(19) United States
(12) Patent Application Publication
(10) Pub. No.: US 2009/0305793 A1
(43) Pub. Date: Dec. 10, 2009

(54) Rotary homokinetic joint

(76) Inventor: Peter Bongartz, Sankt Augustin (DE)

Correspondence Address: MILES & STOCKBRIDGE PC, 1751 PINNACLE DRIVE, SUITE 500, MCLEAN, VA, 22102-3833, US

(21) Appl. No.: 11/659,474

(22) PCT Filed: Aug. 6, 2004
(86) PCT No.: PCT/EP04/08855

§ 371 Date: Jun. 5, 2009

(51) Int. Cl. F16D 3/205

(52) U.S. Cl. 464/11

(57) ABSTRACT

The invention relates to a rotary homokinetic joint (1) which comprises an outer joint part (2) having an outer surface (3) and an inner surface (4), said outer joint part (2) comprising at least three guide tracks (6), evenly distributed across the periphery of the inner surface (4) and extending in the axial direction, an inner joint part (8) comprising at least three pivots (10), evenly distributed across the periphery and extending in the radial direction, and antifriction bearings (12), arranged between the outer joint part (2) and the inner joint part (8) and borne on the pivots (10). Every antifriction bearing (12) comprises antifriction bearing outer surfaces (14) which are adapted to the guide tracks (6) of the outer joint part (2) for the purpose of linear displacement of the inner joint part (14) in the axial direction. Said guide tracks (6) comprise two opposite lateral guide surfaces (16) each for guiding the antifriction bearing (12) in the axial direction. The rotary homokinetic joint is characterized in that every lateral guide surface (16) is made up of at least two linear surfaces (18a, 18b) running at a defined angle (α) in relation to each other in such a manner that an antifriction bearing (12) inserted into a guide track (6) is supported in at least two contact areas (20) on a lateral guide surface (16) of the guide track (6) corresponding to the direction of loading.

### BACKGROUND OF THE INVENTION

The present invention relates to a rotary homokinetic joint according to the preamble of claim 1.

Rotary homokinetic joints are widely known and used in the drive train of vehicles, e.g., in steerable driven axles and for equalizing the vehicle spring system at the driven wheels.

Such rotary homokinetic joints are advantageous in that a relatively large angle between the driving portion and the driven portion of the joint can be made possible while a uniform vibration-free torsion transmission is maintained.

Rotary homokinetic joints are known from the Laid-Open documents DE 4210894 A1 and DE 10206733 A1. These documents respectively describe a rotary homokinetic joint of the tripod type where antifriction bearings with a curved outer surface are inserted into tracks of the outer joint part. The curvature of the lateral guide surfaces of the tracks is matched to the antifriction bearing so that each of the antifriction bearings is supported in at least one contact area in the guide track of the outer joint part.

The disadvantage of this state of the art is that the geometric shape of the lateral guide surfaces of the tracks requires great manufactural efforts because of the curvature. Moreover, there is a relatively high Hertzial stress (stress occurring during the contact of two bodies according to Hertz' theory) at the contact areas when loaded so that a material fatigue may occur at these areas. Further, the antifriction bearing has a relatively great clearance, the so-called backlash, in the track which may result in a tilting movement of the bearing in the track and thus to an unsteady movement of the rotary joint. The rotary homokinetic joint according to the Laid-Open document DE 102 06 733 A1 further comprises an inner ring of the antifriction bearing adapted to the curvature of the pivots of the inner joint part so that higher tilting forces act upon the antifriction bearing via the pivot.

### SUMMARY OF THE INVENTION

Therefore, it is the object of the present invention to improve a rotary homokinetic joint of the afore-mentioned type in such a manner that a low Hertzial stress between the antifriction bearing and the outer joint part is made possible while, however, a minor freedom of movement of the bearing in the guide track is permitted and the disadvantages of prior art are avoided.

This object is solved, according to the invention, by the features of claim 1.

The invention advantageously provides that the guide tracks arranged in the outer joint part and comprising two opposite lateral guide surfaces each for guiding the antifriction bearing are configured such that every lateral guide surface is made up of at least two linear surfaces running at a defined angle in relation to each other in such a manner that an antifriction bearing inserted into a guide track is supported in at least two contact areas on a lateral guide surface of the guide track corresponding to the direction of loading. The force occurring in the direction of loading is thus distributed onto two different contact areas so that the Hertzial stress at the contact areas between the antifriction bearing outer surface and the guide surface of the guide track is reduced. Moreover, a smaller backlash can be realized so that a uniform movement of the rotary homokinetic joint is made possible. Because of the geometrically simple linear surfaces of the lateral guide surfaces of the guide tracks, the outer joint part can be manufactured relatively easily and at low costs.

In an advantageous development of the invention, it is provided that the antifriction bearing outer surface of the antifriction bearing is spherical, the center of the spherical shape lying on the central axis of the antifriction bearing. This is advantageous in that the antifriction bearing outer surface can be manufactured easily and with high precision due to the spherical shape, whereby a small gap and a minor freedom of movement can be made possible between the antifriction bearing outer surface and the guide surfaces. Moreover, a uniform contact of the antifriction bearing to the lateral guide surface is possible whereby the at least two contact areas between the lateral guide surface and the antifriction bearing outer surface are evenly loaded.

Alternatively, the antifriction bearing outer surfaces of the antifriction bearing may have a curvature in a plane extending orthogonally to the equatorial plane of the antifriction bearing the radius of which is larger than the outer radius in the equatorial plane of the antifriction bearing. Due to the larger radius, this permits an enlargement of the contact areas between the antifriction bearing outer surface and the guide surface whereby the Hertzial stress at the contact areas is lower.

A preferred embodiment provides that the angle of the linear surfaces of the lateral guide surface extending towards each other is adapted to the curvature of the antifriction bearing outer surface. Thus, a particularly good contact of the guide track to the antifriction bearing outer surface is possible whereby the backlash can be kept very small.

Preferably, it is provided that, upon contact, each of the linear surfaces of the lateral guide surface respectively forms a tangential plane to the curvature of the antifriction bearing outer surface at the contact areas of the antifriction bearing.

In a particularly preferred embodiment, the connecting line from the center of curvature of the antifriction bearing outer surface to one of the contact areas between the antifriction bearing outer surface and the lateral guide surface forms an angle with the equatorial plane of the antifriction bearing, which amounts to between 0.5° and arcsin [B/(2·r)]0.5°, preferably between 2° and arcsin [B/(2·r)]−2°, where r is the radius of curvature of the antifriction bearing outer surface and B is the width of the antifriction bearing in axial direction of the antifriction bearing. Thus, it is guaranteed that the contact areas between the antifriction bearing outer surface and the lateral guide surface are sufficiently spaced from the lateral edges of the antifriction bearing so that the material does not break at the antifriction bearing outer surface. Moreover, the two contact areas at the antifriction bearing outer surface are sufficiently spaced to ensure a tilting stability of the antifriction bearing in the guide track.

In a particularly preferred embodiment, it is provided that an antifriction bearing inserted into a guide track has a clearance between the antifriction bearing outer surface and the lateral guide surfaces of 0.2 mm at maximum, preferably of 0.1 mm at maximum. This permits that in case of a slight tilt of the antifriction bearing in the guide track, a sufficient lubrication between the guide track and the antifriction bearing is possible so that the antifriction bearing can be linearly displaced in the guide track without any problem.

In a particularly preferred embodiment, it is provided that the antifriction bearing is rounded at the end edges and that the antifriction outer surface forms a raised surface stepped from the end edges. Such a raised surface permits an easy manufacture of such antifriction bearings with a smoothed surface of the antifriction bearing outer surface, which is necessary for the uniform and trouble-free run of the antifriction bearing in the guide track.

In a preferred embodiment, the invention provides that a lubricant channel is respectively arranged between the lateral guide surfaces of the guide track and the antifriction bearing outer surfaces. This lubricant channel may be located between the sites of contact between the antifriction bearing surfaces and the lateral guide surfaces. Providing the lubricant channel guarantees in a simple manner that the antifriction bearing in the guide tracks is always sufficiently lubricated and a smooth run of the antifriction bearings in the guide tracks is thus permitted.

Preferably, it is provided that each of the pivots of the inner joint part has a barrel shape coaxial to the axis of the pivot. Preferably, the barrel shape has circular curvatures of the outer surface in two planes orthogonal to each other. The radius of curvature of the outer surface in the plane of the axis is preferably smaller than the radius of the barrel shape in the equatorial plane orthogonal to the axis of the pivot. This circular curvature permits a simple insertion of the pivot into the inner ring of the antifriction bearing. Moreover, the tilting movement of the pivot in the antifriction bearing inner ring resulting from the bending of the rotary homokinetic joint is improved.

The antifriction bearing has an inner surface, the inner surface and a pivot of the joint inner part being adapted to each other in such a manner that the pivot is linearly displaceable in axial direction of the antifriction bearing. Because of the possibility of the linear displacement of the pivot in the antifriction bearing, a smaller axial force is exerted upon the antifriction bearing whereby the tilting risk of the antifriction bearing is reduced. Moreover, the pivot can be inserted into the antifriction bearing in a particularly simple manner. Moreover, the production and fine machining of such inner surfaces can be effected in a relatively simple manner and at low costs.

The antifriction bearing may consist of an antifriction bearing inner ring and an antifriction bearing outer ring having roll bodies arranged therebetween, the antifriction bearing inner ring and the antifriction bearing outer ring being fixed with respect to each other in axial direction of the antifriction bearing. This permits the assembly of the antifriction bearings even before they are arranged on the inner joint part whereby the mounting of the rotary homokinetic joint is made easier. In a preferred embodiment, the roll bodies are fixed in the antifriction bearing outer ring. When assembling the antifriction bearing, the antifriction bearing inner ring may thus be simply displaced into the antifriction bearing outer ring in such a manner that the roll bodies are located between the antifriction bearing outer ring and the antifriction bearing inner ring.

In an advantageous development, the antifriction bearing inner ring is fixed with respect to the antifriction bearing outer ring by means of a spring ring and/or a flat ring. Alternatively, the antifriction bearing inner ring can be fixed with respect to the antifriction bearing outer ring by means of a pressed-in ring. Both alternatives offer a simple possibility to fix the antifriction bearing inner ring with respect to the antifriction bearing outer ring. Since the pivot is linearly displaceable in axial direction in the inner ring of the antifriction bearing in one embodiment, no major axial forces do occur between the antifriction bearing inner ring and the antifriction bearing outer ring so that the spring rings, flat rings and/or pressed-in rings correspondingly do not have to accommodate any major axial forces either. Further, this fixing permits the simple assembly of the antifriction bearing prior to its installation into the rotary homokinetic joint so that it can be installed as a unit.

In a preferred embodiment of the invention, the outer surface of the outer joint part has the shape of a circular cylinder or a tripod.

Hereinafter, the invention is explained in detail with reference to the Figures.

### BRIEF DESCRIPTION OF THE DRAWINGS

FIG. 1 is a perspective exploded view of a rotary homokinetic joint according to the invention.

FIG. 2 is a cross-sectional schematic view of an outer joint part according to the invention, with an inserted inner joint part and antifriction bearings.

FIG. 3 is a cross-sectional view of an embodiment of an antifriction bearing in detail.

FIG. 4 is a cross-sectional view of another embodiment of an antifriction bearing according to the invention.

FIG. 5 is a detailed partial view of an antifriction bearing inserted into a guide track.

FIG. 6 is a detail view of an antifriction bearing set on a pivot.

### DESCRIPTION OF THE PREFERRED EMBODIMENTS

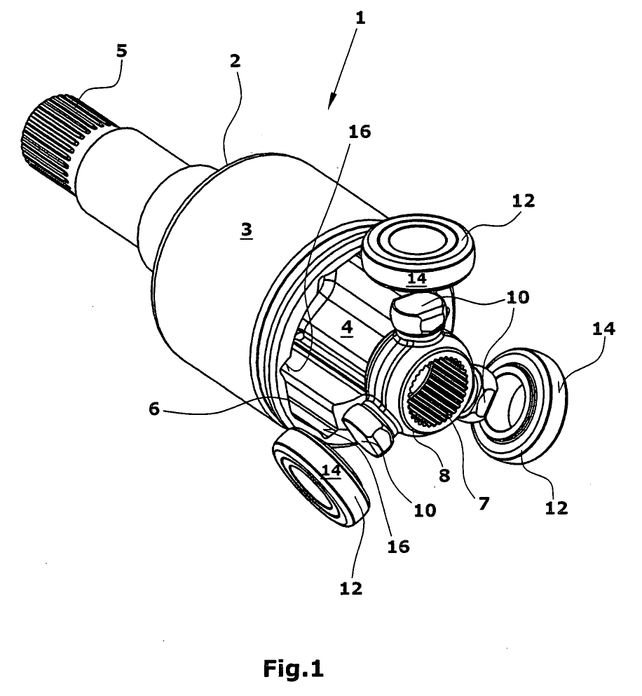

In FIG. 1, a rotary homokinetic joint 1 according to the invention is shown in an exploded view. The rotary homokinetic joint is made up of a pot-shaped outer joint part 2 and an inner joint part 8. At its distal end, the outer joint part 2 is provided with a shaft 5 with a spline toothing which may serve as connection to drive shafts on the axle drive side or also as connection to a driven shaft.

The outer joint part 2 has an outer surface 3 and an inner surface 4. At least three guide tracks 6 extending in axial direction of the outer joint part 2 are recessed over the circumference of the inner surface 4 in a uniformly distributed manner. In the illustrated embodiment, the outer surface 3 has the shape of a circular cylinder. Alternatively, the outer surface of the outer joint part 2 may also have a tripodal shape or a tulip shape. The circularly cylindrical shape, however, is advantageous in that its production is very simple.

The inner joint part 8 has an annular structure. In the interior, a ring 7 with a spline toothing is arranged to which a drive or driven shaft may be connected.

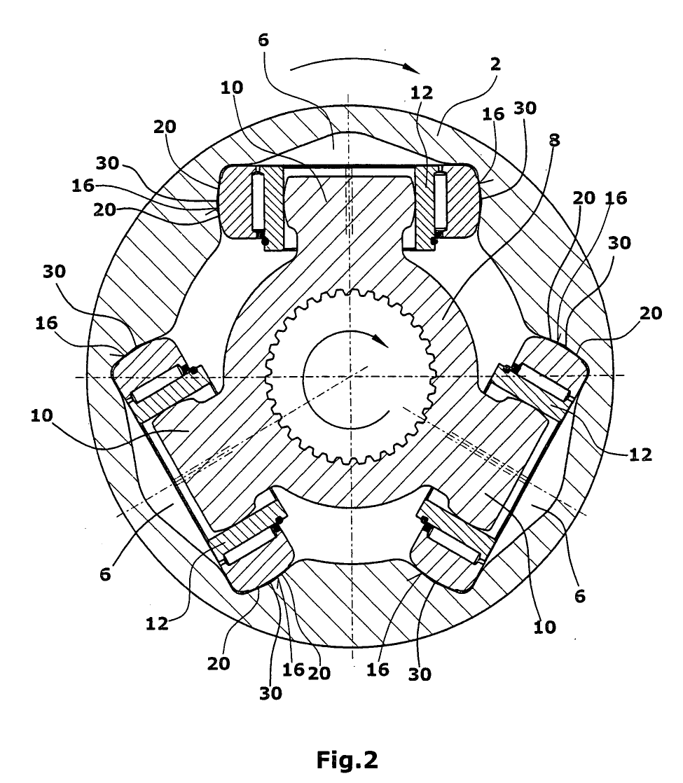

The inner joint part 8 of FIG. 2 comprises pivots 10 which extend radially at an angle of 120° relative to each other and the number of which corresponds to that of the guide tracks 6 of the outer joint part 2. The preferred embodiment shown in FIG. 2 has three guide tracks 6 and three pivots 10, the inner joint part 8 having the shape of a tripod star.

Antifriction bearings 12 are pushed upon the pivots 10. The guide tracks 6 of the outer joint part 2 and the antifriction bearings 12 are adapted to each other in such a manner that the inner joint part 8 can be pushed into the outer joint part 2, with the antifriction bearings 12 pushed thereon, such that the antifriction bearings 12 are linearly displaceable in the guide tracks 6 of the outer joint part 2 in axial direction of the rotary homokinetic joint 1. The antifriction bearings 12 are guided by the lateral guide surfaces 16 of the guide tracks 6, the antifriction bearings 12, with the antifriction bearing outer surfaces 14, sliding along the lateral guide surfaces 16.

FIG. 2 illustrates a rotary homokinetic joint according to the invention in cross-section. The antifriction bearings 12 are set upon the pivots 10 of the inner joint part 8 and have been inserted into the outer joint part 2 together with the inner joint part 8. In the embodiment illustrated in FIG. 2, the outer joint part 2 represents the driving portion of the rotary homokinetic joint 1 while the inner joint part 8 is a driven portion. The outer joint part 2 is driven in correspondence with the rotational direction indicated by the arrow. Corresponding to this direction of loading, the guide surfaces 16 of the guide tracks 6 abut against the antifriction bearing outer surface 14 of the antifriction bearings 12. Between each of the lateral guide surfaces 16 of a guide track 6 and the antifriction bearing surface 14 of an antifriction bearing 12, there are at least to contact areas 20, respectively. Thus, a rotary movement can be transferred from the outer joint part 2 to the inner joint portion 8, which is also indicated by an arrow of the rotational direction.

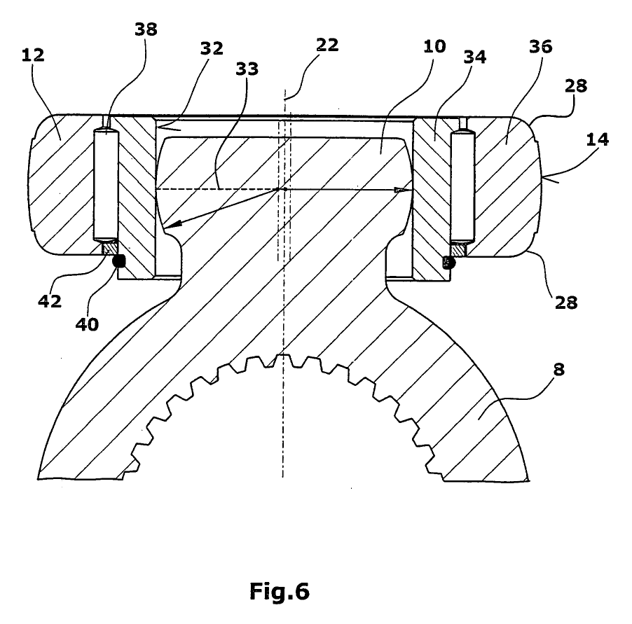

For a better comprehension of the supporting mechanism, FIG. 5 schematically shows a detail view of a guide track 6 with an inserted antifriction bearing 12 in the unloaded condition. In the illustrated embodiment, the lateral guide surface 16 consists of two linear surfaces 18a and 18b extending at a defined angle α with respect to each other. The antifriction bearing outer surface 14 has a curvature with a constant radius to which the angle α of the linear surfaces 18a and 18b is adapted such that each of the linear surfaces 18a and 18b forms a tangential plane to the curvature of the antifriction bearing outer surface at the contact areas 20. The gap between the lateral guide surface 16 and the antifriction bearing outer surface 14 is enlarged in the region of the contact edge of the two linear surfaces 18a and 18b so that a lubricant channel 30 is formed.

Because of the at least two contact areas 20 between the guide surface 16 and the antifriction bearing outer surface 14, the force to be transmitted is equally distributed among both contact areas 20 so that the Hertzial stress prevailing at the contact areas 20 is lower than with prior art. Moreover, the tilting stability of the antifriction bearing 12 in the guide track 6 is increased since the clearance between the guide track 6 and the antifriction bearing 12 may be kept particularly small. Since the lateral guide surfaces 18a and 18b are linearly configured in longitudinal direction, they can be easily manufactured and smoothed very well. Thus, a clearance or gap width of 0.2 mm at maximum, partly even of 0.1 mm at maximum, is possible.

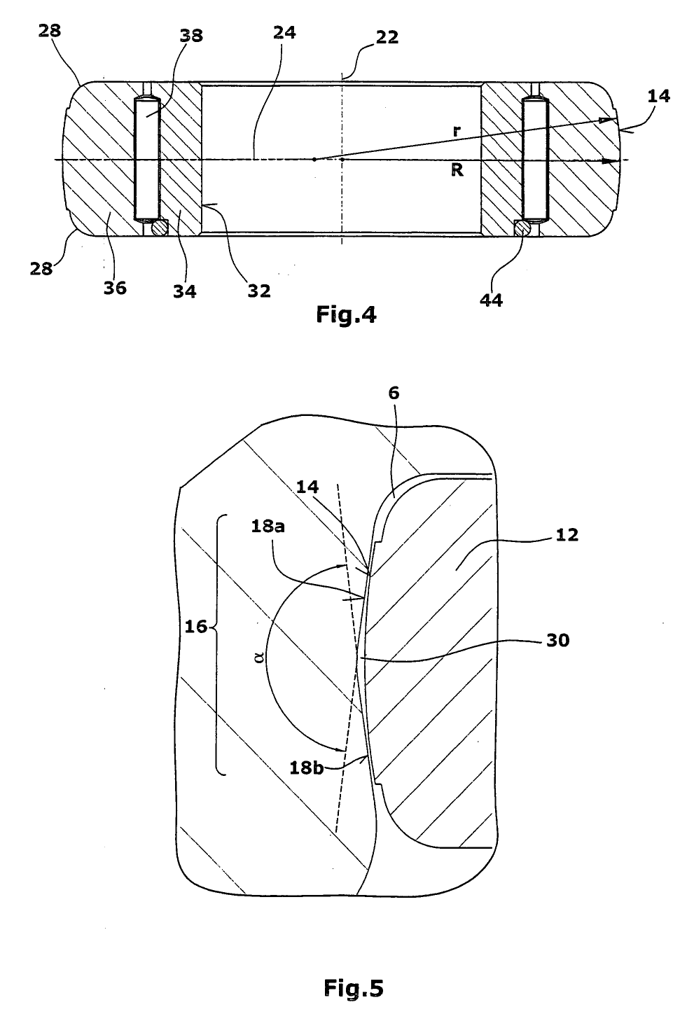

As can be seen best in FIG. 4, the shape of the antifriction bearing outer surface 14 has two different radii R and r. The radius R describes the radius of the antifriction bearing 12 in the equatorial plane 24 orthogonal to the axial axis of the antifriction bearing. Consequently, it describes the nominal diameter (maximum outer diameter) of the antifriction bearing 12. The curvature of the antifriction bearing outer surface 14 of the antifriction bearing 12 in the picture plane of FIG. 4 comprises the radius r. In the embodiment illustrated in FIG. 4, the radius r is larger than the radius R. In a non-illustrated embodiment, the radii R and r are equal so that the antifriction bearing outer surface 14 describes a spherical layer of a sphere with a center on the central axis 22 of the antifriction bearing 12, said layer being symmetrical to the equatorial plane. It is advantageous, however, when the radius r of the curvature of the antifriction bearing outer surface 14 in axial direction of the antifriction bearing 12 is chosen as large as possible since the contact areas 20 between the antifriction bearing outer surface 14 and the lateral guide surface 16 of the guide tracks 6 are enlarged in this manner and thus, the Hertzian stress at the contact areas 20 is reduced.

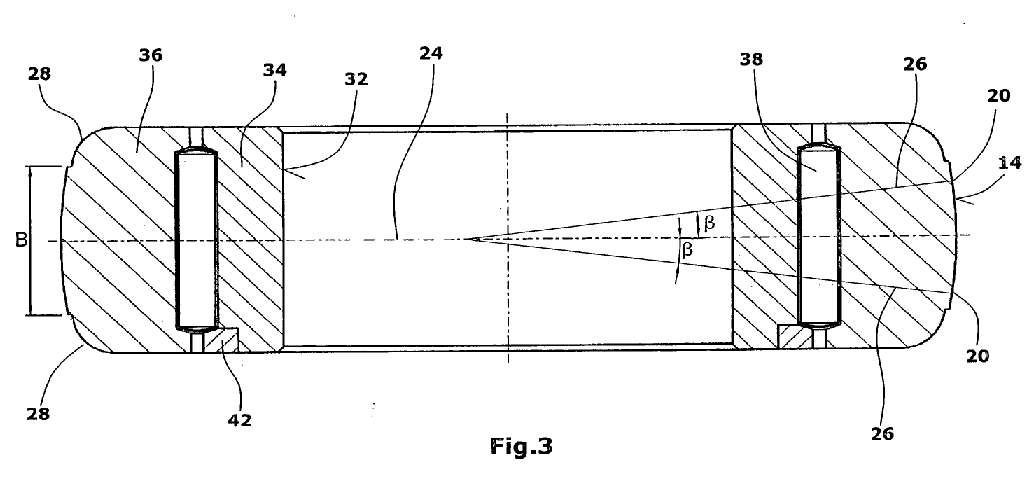

As can be seen best in FIG. 3, the antifriction bearings 12 comprise stepped end edges 28 so that the antifriction bearing outer surface 14 forms a raised rolling surface stepped from the end edges 28. In a non-illustrated embodiment, the end edges 28 of the antifriction bearing 12 are not rounded so that the antifriction bearing outer surface 14 extends to the end edges 28. The embodiment illustrated in FIG. 3, however, is advantageous in that the antifriction bearing outer surface 14 can be finished or smoothed particularly well because of the raised configuration. When selecting the angle α between the linear surfaces 18a, 18b of the lateral guide surface 16 and the radius R of the curvature of the antifriction bearing outer surface 14, it has to be considered that the contact areas 20 between the antifriction bearing outer surface 14 and the lateral guide surface 16 should be spaced as far as possible to ensure that the tilting stability of the antifriction bearing in the guide track is as high as possible, but that they may only lie so close to the end edges 28 or the lateral edges of the antifriction bearing outer surface 14 that the material at the antifriction bearing outer surface 14 does not break for reasons of pressure load at the contact areas 20.

Preferably, the connecting line 26 from the center of the curvature to one of the contact areas 20 between the antifriction bearing outer surface 14 and the lateral guide surface 16 forms an angle β with the equatorial plane 24 of the antifriction bearing 12, which lies in the range of between 0.5° and arcsin [B/(2·r)]−0.5°. In a particularly preferred embodiment, the angle β lies between 2° and arcsin [B/(2·r)]−2°. In this case, r represents the radius of curvature and, as illustrated in FIG. 3, B represents the width of the antifriction bearing outer surface in axial direction of the antifriction bearing 12.

As can be seen in FIGS. 3, 4 and 6, the antifriction bearings 12 are made up of an antifriction bearing inner ring 34 and an antifriction bearing outer ring 36. Roll bodies 38 are arranged between the antifriction bearing rings. The antifriction bearing inner ring 34 has an inner surface 32, the latter and the pivots 10 of the inner joint part 8 being adapted to each other such that the pivot 10 is able to slide on the inner surface 32 and is thus able to tilt in the antifriction bearing 12 or to be linearly displaced with respect to the antifriction bearing 12.

In the embodiment illustrated in FIG. 6, the pivot 10 has the shape of a barrel where the radius of curvature is smaller in axial direction of the pivot than the radius of the pivot in the equatorial plane 33 of the pivot. In other words, the radius of curvature is smaller than the radius defining the nominal diameter of the pivot 10. This so-called radius offset is schematically indicated in FIG. 6 by the lines drawn in parallel to the center line 22 of the pivot 10. This barrel shape has the advantage that the pivot 10 is able to tilt more easily in the antifriction bearing 12 and thus exerts lower forces onto the antifriction bearing 12 during the tilting movement. Thereby, the tilt of the antifriction bearing 12 in the guide track 6 is kept low.

The antifriction bearings 12 may have different configurations. The antifriction bearing inner rings 34 are always fixed with respect to the antifriction bearing outer rings 36 in axial direction of the antifriction bearing. Prior to the assembly of an antifriction bearing 12, the roll bodies 38 are fixed in the antifriction bearing outer ring 36. Thereafter, the antifriction bearing inner ring 34 is pushed into the antifriction bearing outer ring 36. As illustrated in FIG. 3, the antifriction bearing inner ring 34 may be fixed with respect to the antifriction bearing outer ring 36 by means of a flat ring. Since no major axial forces occur between the antifriction bearing inner ring 34 and the antifriction bearing outer ring 36, such a flat ring 42 is sufficient for fixing the antifriction bearing inner ring 34 with respect to the antifriction bearing outer ring 36. Alternatively, as illustrated in FIG. 4, the antifriction bearing inner ring may be fixed by means of a pressed-in ring 44. In a third embodiment of the antifriction bearing illustrated in FIG. 6, the antifriction bearing inner ring 34 is fixed with respect to the antifriction bearing outer ring 36 by means of a flat ring 42 and a spring ring 40.

Obviously, the individual features of the present invention may also be realized independently of each other. The shape of the antifriction bearing outer surface 14 described in the description of FIG. 4 may also be employed in other guide tracks than those configured according to the invention. The barrel-shaped pivots 10 may also be employed in other antifriction bearings 12 than those illustrated. Moreover, the arrangement of antifriction bearing inner ring 34 and antifriction bearing outer ring 36 and their fixing with respect to each other is not bound to the shape of the of the antifriction bearing outer surface 14 or the pivot 10.

1. A rotary homokinetic joint (1), consisting of
an outer joint part (2) having an outer surface (3) and an inner surface (4), said outer joint part (2) comprising at least three guide tracks (6) evenly distributed across the periphery of the inner surface (4) and extending in the axial direction,
an inner joint part (8) comprising at least three pivots (10) evenly distributed across the periphery and extending in the radial direction, and
antifriction bearings (12), arranged between the outer joint part (2) and the inner joint part (8) and borne on the pivots (10), each antifriction bearing (12) comprising an antifriction bearing outer surface (14) which is adapted to the guide tracks (6) of the outer joint part (2) for the purpose of linear displacement of the inner joint part (14) in the axial direction,
said guide tracks (6) comprising two opposite lateral guide surfaces (16) each for guiding the antifriction bearing (12) in the axial direction,
characterized in
that each lateral guide surface (16) is made up of at least two linear surfaces (18a, 18b) extending at a defined angle (α) in relation to each other in such a manner
that an antifriction bearing (12) inserted into a guide track (6) is supported in at least two contact areas (20) on a lateral guide surface (16) of the guide track (6) corresponding to the direction of loading.

2. The rotary homokinetic joint according to claim 1, characterized in that the antifriction bearing outer surface (14) of the antifriction bearing (12) is spherical, the center of the spherical shape lying on the central axis (22) of the antifriction bearing (12).

3. The rotary homokinetic joint according to claim 1, characterized in that the antifriction bearing outer surface (14) of the antifriction bearing (12) has a curvature in a plane extending orthogonally to the equatorial plane (24) of the antifriction bearing (12), the radius (r) of said curvature being larger than the outer radius (R) in the equatorial plane (24) of the antifriction bearing (12).

4. The rotary homokinetic joint according to claim 1, characterized in that the angle (α) of the linear surfaces (18a, 18b) of the lateral guide surface (16), extending towards each other, is adapted to the curvature of the antifriction bearing outer surface (14).

5. The rotary homokinetic joint according to claim 1, characterized in that the linear surfaces (18a, 18b) of the lateral guide surface (16) respectively form a tangential plane to the curvature of the antifriction bearing outer surface (14) at the contact areas (20) of the antifriction bearing (12).

6. The rotary homokinetic joint according to, claim 1 characterized in that the connecting line (26) from the center of the curvature to one of the contact areas (20) between the antifriction bearing outer surface (14) and the lateral guide surface (16) forms an angle (β) with the equatorial plane (24) of the antifriction bearing (12) which amounts to between 0.5° and arcsin [B/(2·r)]−0.5°, preferably between 2° and arcsin [B/(2·r)]−2°, where r is the radius of curvature and B is the width of the antifriction bearing outer surface in the axial direction of the antifriction bearing (12).

7. The rotary homokinetic joint according to claim 1, characterized in that an antifriction bearing (12) inserted into a guide track (6) has a clearance of 0.2 mm at maximum, preferably of 0.1 mm at maximum, between the antifriction bearing outer surface (14) and the lateral guide surfaces (18a, 18b).

8. The rotary homokinetic joint according to claim 1, characterized in that the antifriction bearing (12) is rounded at the end edges (28) and that the antifriction bearing outer surface (14) forms a raised surface stepped from the end edges (28).

9. The rotary homokinetic joint according to claim 1, characterized in that between the lateral guide surfaces (16) of the guide tracks (6) and the antifriction bearing outer surfaces (14), a lubricant channel (30) is respectively arranged.

10. The rotary homokinetic joint according to claim 1, characterized in that the pivots (10) of the inner joint part (8) have a barrel shape coaxial to the axis of the pivot (10) each, the barrel shape preferably having circular curvatures of the outer surface in two planes orthogonal to each other.

11. The rotary homokinetic joint according to claim 1, characterized in that the antifriction bearing (12) has an inner surface (32), said inner surface (32) and a pivot (10) of the inner joint part (18) being adapted to each other in such a manner that the pivot (10) is linearly displaceable in the axial direction of the antifriction bearing (12).

12. The rotary homokinetic joint according to claim 1, characterized in that an antifriction bearing (12) is made up of an antifriction bearing inner ring (34) and an antifriction bearing outer ring (36) with roll bodies (38) arranged therebetween, the antifriction bearing inner ring (34) and the antifriction bearing outer ring (36) being fixed with respect to each other in the axial direction of the antifriction bearing.

13. The rotary homokinetic joint according to claim 12, characterized in that the roll bodies (38) are fixed in the antifriction bearing outer ring (36).

14. The rotary homokinetic joint according to claim 12, characterized in that the antifriction bearing inner ring (34) is fixed with respect to the antifriction bearing outer ring (36) by means of a spring ring (40) and/or a flat ring (42).

15. The rotary homokinetic joint according to claim 12, characterized in that the antifriction bearing inner ring (34) is fixed with respect to the antifriction bearing outer ring (36) by means of a pressed-in ring (44).

16. The rotary homokinetic joint according to claim 1, characterized in that the outer surface (3) of the outer joint part (2) has a circularly cylindrical or a tripodal shape.

17. The rotary homokinetic joint according to claim 13, characterized in that the antifriction bearing inner ring (34) is fixed with respect to the antifriction bearing outer ring (36) by means of a spring ring (40) and/or a flat ring (42).

18. The rotary homokinetic joint according to claim 13, characterized in that the antifriction bearing inner ring (34) is fixed with respect to the antifriction bearing outer ring (36) by means of a pressed-in ring (44).
